(19) United States
(12) Patent Application Publication
(10) Pub. No.: US 2025/0206283 A1
(43) Pub. Date: Jun. 26, 2025

(54) ELECTRONICALLY CONTROLLABLE PNEUMATIC BRAKE SYSTEM HAVING A REVERSAL RELAY VALVE FOR PRESSURIZING AND VENTILATING A SPRING BRAKE CYLINDER OF A VEHICLE

(71) Applicant: ZF CV Systems Global GmbH, Bern (CH)

(72) Inventors: Robert Otremba, Ronnenberg (DE); Arne Michaelsen, Seelze (DE); Julian van Thiel, Grossburgwedel (DE)

(21) Appl. No.: 18/991,121

(22) Filed: Dec. 20, 2024

(30) Foreign Application Priority Data
Dec. 22, 2023 (DE) 10 2023 136 454.5

(51) Int. Cl. B60T 13/68; B60T 13/38

(52) U.S. Cl. CPC B60T 13/683; B60T 13/385

(57) ABSTRACT

An electronically controllable pneumatic brake system for a vehicle includes a first service brake circuit having a pressure modulator and an electronic service brake control unit. The brake system furthermore includes a parking brake device having a parking brake module and a reversal relay valve for pressurizing and ventilating at least one first spring brake cylinder. The reversal relay valve has a first control connection, a second control connection, a working connection, a reservoir connection and a vent. The second control connection is connected to an electropneumatic valve arrangement in order to receive a second control pressure. The valve arrangement is actuated by an electronic control unit independent of the electronic service brake control unit. The reversal relay valve is configured to ventilate the spring brake cylinder in a situation wherein the first and second control connection are pressurized and a reservoir pressure prevails at the first reservoir connection.

### CROSS-REFERENCE TO RELATED APPLICATIONS

This application claims priority of German patent application no. 10 2023 136 454.5, filed Dec. 22, 2023, the entire content of which is incorporated herein by reference.

### TECHNICAL FIELD

The disclosure relates to an electronically controllable pneumatic brake system for a vehicle, in particular utility vehicle. The disclosure furthermore relates to a method for controlling a vehicle, in particular utility vehicle, having an electronically controllable pneumatic brake system, to a vehicle including such a brake system, and to the use of a reversal relay valve for pressurizing and ventilating a spring brake cylinder of a vehicle.

### BACKGROUND

Modern utility vehicles commonly have an electropneumatic brake system. The brake system includes spring brakes as parking brakes. These are also referred to as immobilizing brakes. The parking brakes operate under the action of spring force, can be released by pressurization of spring brake cylinders, and can be arrested by ventilation. Within a service brake system, valves for controlling the service brake pressure are electronically actuated. The valves may be provided in, or outside, so-called axle modulators. The axle modulators may be automated or partially automated, and/or may be electronically actuatable by an autonomous unit. The parking brakes are also electronically actuated. It is known in particular for the pressurization or ventilation of the spring brake cylinders to be controlled by operation of a solenoid valve. The spring brake cylinders may be combined with service brake cylinders, such that the spring brake and service brake act on the same brake pistons. Suitable configuration measures may be implemented in order to avoid mechanical overloading of the brake pistons as a result of summation of braking forces from the service brakes and the spring brakes. If the service brakes are operated while the parking brakes are active, the spring brake cylinders are simultaneously pressurized in order to thus avoid summation of the braking forces. Such a function is also referred to as an “anti-compound function”.

Safety concepts are of high relevance in electropneumatic brake systems for modern vehicles. In particular in vehicles with automated or partially automated driving functions, braking functions must remain available at least to a restricted degree even in the event of a fault or an electrical failure of a control unit. Only in this way can the safety of the vehicle, its occupants and other road users be ensured. For this purpose, it is known to provide redundancy levels that can continue to provide an at least restricted braking function even in the event of failure of a primary system.

A redundancy level is also desired for the parking brake, because in most cases, vehicles can be safely parked only with the parking brake engaged. To enhance functionality, and in particular to be able to ventilate the corresponding spring brake cylinders of the parking brake and thus safely park the vehicle irrespective of the occurrence of a fault in any of the various levels, be it the operational level or a redundancy level of the brake system, it is desirable for the spring brake cylinders to be capable of being actuated via two independent paths in order to be ventilated. It is thus sought to increase the functionality and the operational readiness of the vehicle in order to be able to ensure that the vehicle can be safely parked even in the event of one or more faults in the brake system.

US 2024/0246520 has disclosed a method for operating an electropneumatic brake system for a vehicle, wherein the brake system includes a service brake system and a parking brake system, wherein the parking brake system includes at least one spring brake cylinder. The method is characterized by the steps: providing, via a control unit, a control signal for maintaining a spring accumulator pressurization pressure with which the at least one spring brake cylinder is pressurized; stopping the provision of the control signal in the event of a fault and/or an electrical failure and/or in a diagnostic situation of the control unit; thus automatically ending the maintaining of the spring accumulator pressurization pressure in order to ventilate the at least one spring brake cylinder; thus triggering a spring accumulator failure braking operation of the vehicle via the parking brake system, with the spring accumulator pressurization pressure being vented by way of a service brake ventilation function of the service brake system. The service brake ventilation function makes it possible to realize at least one, in particular continuously or intermittently opened, ventilation path in the service brake system for the purposes of ventilating the at least one spring brake cylinder. The service brake ventilation function is implemented in particular via a valve in the service brake system, preferably an outlet valve and/or a further outlet valve.

Further partially redundant systems are known from US 2024/0375628, US 2024/0198991, US 2024/0182011, US 2023/0311828 and US 2017/0072930.

Even though redundant options for engaging a parking brake have already been created by known systems, there is a demand for further improvements. In particular, in the case of the aforementioned known options, the outlay on assembly and production can be high, because the connection to the service brake system can require long line paths. Furthermore, the achievable system dynamics can be restricted.

### SUMMARY

It is therefore an object of the present disclosure to specify an electronically controllable pneumatic brake system having an improved parking brake device which allows a spring brake cylinder to be easily and/or reliably ventilated even in a redundancy situation.

In a first aspect of the disclosure, the object is achieved by an electronically controllable pneumatic brake system for a vehicle, in particular utility vehicle. The electronically controllable pneumatic brake system has at least one first service brake circuit having a first service brake pressure modulator. The service brake pressure modulator has at least one first service brake pressure connection for modulating a service brake pressure for at least one first service brake actuator of the vehicle, wherein the service brake pressure modulator is connected to a first compressed-air reservoir in order to receive reservoir pressure. The electronically controllable pneumatic brake system furthermore has an electronic service brake control unit, which is connected to the service brake pressure modulator and provides primary switching signals thereto for the purposes of switching at least one electromagnetic valve of the first service brake pressure modulator. The electronically controllable pneumatic brake system furthermore has a parking brake device. The parking brake device includes a parking brake module having a parking brake pressure connection, wherein the parking brake module is configured to provide a parking brake pressure at the parking brake pressure connection. The parking brake device furthermore includes a reversal relay valve for pressurizing and ventilating at least one first spring brake cylinder of the vehicle. The reversal relay valve has a first control connection, a second control connection, a working connection, at least one first reservoir connection and a vent. The first control connection is connected to the parking brake pressure connection in order to receive the parking brake pressure, the working connection is connected to the spring brake cylinder, and the second control connection is connected to an electropneumatic valve arrangement in order to receive a second control pressure, wherein the electropneumatic valve arrangement is actuated by an electronic control unit which is independent of the parking brake module. The second control pressure differs from, and is preferably independent of, the service brake pressure. The reversal relay valve is configured to pressurize the spring brake cylinder in a situation in which the first control connection is pressurized, the second control connection is ventilated and a reservoir pressure prevails at the first reservoir connection, and to ventilate the spring brake cylinder in a situation in which the first and the second control connection are pressurized and a reservoir pressure prevails at the first reservoir connection.

The inventors have recognized that, with a parking brake device which has not only the parking brake module but also a reversal relay valve, wherein the reversal relay valve has at least two control connections, the at least first spring brake cylinder can be ventilated via two mutually independent paths in order to thus arrest a parking brake that is associated with the first spring brake cylinder. It should be understood that the reversal relay valve can be actuated in a known manner via the first control connection, that is, the first spring brake cylinder is pressurized when a control pressure prevails at the first control connection, and the first spring brake cylinder is ventilated when no control pressure prevails. By contrast, the second control connection can be understood to be a control connection with an inverse function, that is, by applying a second control pressure to the second control connection, it can be achieved that the spring brake cylinder is ventilated, even if the first control connection is pressurized. The inventors have recognized that, by connecting the second control connection to an electropneumatic valve arrangement which is actuated by an electronic control unit which is independent of the parking brake module, the second control connection can be actuated, and the vehicle can thus be safely parked by virtue of the spring brake cylinder being ventilated, even in a situation in which a fault has occurred in the parking brake module. The parking brake module, which can also be referred to as an electronic parking brake module, is thus to be regarded as a primary unit of the parking brake device, which in the normal situation is configured to arrest the parking brake of the vehicle. Via the second control connection of the reversal relay valve, a facility is created which is redundant in relation to the parking brake module and which allows the parking brake to be arrested if a fault occurs in the parking brake module.

In an embodiment, the reversal relay valve has a third control connection. The third control connection is connected to the first service brake pressure connection in order to receive the service brake pressure. The reversal relay valve is configured to pressurize the spring brake cylinder in a situation in which the first control connection and the third control connection are pressurized, the second control connection is pressurized or ventilated, and a reservoir pressure prevails at the first reservoir connection, and/or to ventilate the spring brake cylinder in a situation in which the first and the second control connection are pressurized, the third control connection is ventilated and a reservoir pressure prevails at the first reservoir connection, and/or to pressurize the spring brake cylinder in a situation in which the second and the third control connection are pressurized, the first control connection is ventilated and a reservoir pressure prevails at the first reservoir connection. It should be understood that the third control connection of the reversal relay valve is in particular provided and configured to provide an anti-compound function. If the service brakes are operated while the parking brake is arrested, that is, while the spring brake cylinder is in a ventilated state, the third control connection is charged with the service brake pressure, or pressurized. Pressurization of the third control connection causes the first spring brake cylinder to be pressurized, and the associated parking brake to be released. It should be understood that the compressed air which is provided by the reversal relay valve in order to pressurize the spring brake cylinder is proportional to the service brake pressure which is provided at the third control connection. It should furthermore be understood that simultaneous application of service brake pressure to the third control connection and of a second control pressure to the second control connection has no influence on the anti-compound function of the reversal relay valve.

The service brake pressure modulator and the electronic service brake control unit are preferably integrated in one module. The service brake pressure modulator and the electronic service brake control unit are preferably implemented as a structural unit. The service brake pressure modulator and the electronic service brake control unit are preferably units of a primary system of the electronically controllable pneumatic brake system. The service brake pressure modulator is preferably a rear-axle service brake pressure modulator, that is, a service brake pressure modulator which is configured to modulate a service brake pressure for at least one first service brake actuator at a rear axle of the vehicle.

The electropneumatic valve arrangement is preferably independent of a service brake function of the electronically controllable pneumatic brake system. The electropneumatic valve arrangement is preferably independent of the service brake system. Although the electropneumatic valve arrangement can receive reservoir pressure from a compressed-air reservoir assigned to the service brake function, the electropneumatic valve arrangement is independent of the pressures modulated by the service brake function. It can also be preferred that the electropneumatic valve arrangement is not actuated by an electronic control unit assigned to the service brake function.

The electropneumatic valve arrangement is furthermore preferably bistable. That is, it has at least two stable switching positions and maintains each of these switching positions even if energization is withdrawn. In a fault situation which leads to a failure of the voltage supply provided for the electropneumatic valve arrangement, the withdrawal does not change the switching position of the electropneumatic valve arrangement, such that any pressure which was previously being modulated can continue to be modulated even if the energization is withdrawn.

The electropneumatic valve arrangement preferably has a relay valve having a relay valve reservoir connection, a relay valve working connection and a relay valve control connection. The relay valve working connection is preferably connected to the second control connection of the reversal relay valve. The electropneumatic valve arrangement preferably has a first electromagnetic switching valve which is configured such that, when energized, it allows compressed air to pass through from the first compressed-air reservoir to the relay valve control connection. In this respect, it should be understood that a first inlet of the first electromagnetic switching valve is preferably connected to the first compressed-air reservoir, and that a first outlet of the first electromagnetic switching valve is preferably connected to the relay valve control connection. The first electromagnetic switching valve is preferably actuated by the electronic control unit, which is independent of the parking brake module. The first electromagnetic switching valve may be a 2/2 directional valve or a 3/2 directional valve. Thus, if the first electromagnetic switching valve is now actuated or energized, the first electromagnetic switching valve switches into a position in which compressed air can flow from the first compressed-air reservoir to the relay valve control connection, such that the relay valve is actuated. If the relay valve is actuated, it opens, and opens up a flow path between the relay valve reservoir connection and the relay valve working connection. The compressed air then passes as second control pressure from the relay valve working connection to the second control connection of the reversal relay valve. The relay valve reservoir connection is preferably connected at least to the first compressed-air reservoir.

In an embodiment, the electropneumatic valve arrangement has a second electromagnetic switching valve. The second electromagnetic switching valve has a pass-through position and a ventilation position. The second electromagnetic switching valve is preferably situated in the pass-through position when deenergized, and in the pass-through position connects the relay valve working connection to the relay valve control connection. The second electromagnetic switching valve is thus preferably configured to provide a latch function for the relay valve. Therefore, to pressurize the second control connection of the reversal relay valve, it is not necessary for the first electromagnetic switching valve to be permanently energized. Brief energization of the first electromagnetic switching valve is sufficient; the latch function means that the relay valve subsequently remains actuated and in the open position, whereby the second control connection of the reversal relay valve remains pressurized. Only when the second electromagnetic switching valve is actuated or energized does it switch, preferably into the ventilation position. In the ventilation position, the latch function of the relay valve is interrupted, and the second control connection of the reversal relay valve is no longer pressurized. The second electromagnetic switching valve is preferably configured as a 3/2 directional valve. The second electromagnetic switching valve is preferably actuated by the electronic control unit, which is independent of the parking brake module.

It is preferable for a reservoir double check valve to be arranged upstream of the relay valve reservoir connection, wherein a first reservoir double check valve inlet is connected to the first compressed-air reservoir, and a second reservoir double check valve inlet is connected to a second compressed-air reservoir. The first compressed-air reservoir is preferably independent of the second compressed-air reservoir. If the first compressed-air reservoir becomes or is empty, that is, for example, has a fault, compressed air can continue to be provided at the relay valve reservoir connection from the second compressed-air reservoir. The second compressed-air reservoir may be a compressed-air reservoir for a redundancy brake pressure modulator of the electronically controllable pneumatic brake system, or may be some other compressed-air reservoir which is independent of the first compressed-air reservoir.

In an embodiment, the electropneumatic valve arrangement has a select-low valve and has a pneumatically switchable valve having a pneumatic control connection. The pneumatically switchable valve preferably has a pass-through position and a ventilation position. The select-low valve preferably has a first select inlet, a second select inlet and a select outlet. The first select inlet is preferably connected to the pneumatically switchable valve, the second select inlet is preferably connected to the first electromagnetic switching valve, and the select outlet is preferably connected to the relay valve control connection. The pneumatically switchable valve is preferably configured to ventilate the first select inlet in response to a pneumatic control pressure at the pneumatic control connection. It should be understood that the select-low valve is configured to always output the lower of the pressures prevailing at the two select inlets via the select outlet. The select-low valve is preferably configured to connect that select inlet at which the lower pressure prevails to the select outlet. Thus, if no pressure prevails at one of the two select inlets or at both select inlets, it is also the case that no pressure prevails at the select outlet. If no pressure prevails at the select outlet, it is also the case that no pressure prevails at the relay valve control connection, unless the above-described latch function has previously been initiated. If no pressure prevails at the relay valve control connection, the relay valve remains in, or switches into, a closed position, in which the flow path between the relay valve reservoir connection and the relay valve working connection is closed.

The pneumatic control connection of the pneumatically switchable valve is preferably connected to the first service brake pressure connection, or to a brake pressure connection of a front-axle brake pressure modulator, or to a brake pressure connection of a redundancy brake pressure modulator, in order to receive a pneumatic control pressure. Thus, if the service brakes are operated, the pneumatically switchable valve is actuated with a brake pressure from either the service brake pressure modulator, the front-axle brake pressure modulator or the redundancy brake pressure modulator, wherein it should be understood that the brake pressures from the service brake pressure modulator, from the front-axle brake pressure modulator and from the redundancy brake pressure modulator may have different pressure levels. In response to a brake pressure at the pneumatic control connection, the pneumatically switchable valve preferably switches into the ventilation position and thus ventilates the first select inlet. Consequently, it is also the case that no pressure prevails at the select outlet.

It is preferred that the first electromagnetic switching valve is connected to the first service brake pressure connection, or to a brake pressure connection of a front-axle brake pressure modulator, or to a brake pressure connection of a redundancy brake pressure modulator, wherein the first electromagnetic switching valve is configured such that, when deenergized, it allows a brake pressure to pass through to the relay valve control connection. In this respect, it is particularly preferred that the first electromagnetic switching valve is configured as a 3/2 directional valve. A first inlet of the first electromagnetic switching valve is preferably connected to the first compressed-air reservoir, as already described above. A second inlet of the first electromagnetic switching valve is preferably connected to the service brake pressure connection or to a brake pressure connection of a front-axle brake pressure modulator or to a brake pressure connection of a redundancy brake pressure modulator. In particular, it is preferred that the first outlet of the first electromagnetic switching valve is connected to the second select inlet. The brake pressure thus preferably does not pass directly to the relay valve control connection; rather, it is preferred that the select-low valve is arranged between the first outlet of the first electromagnetic switching valve and the relay valve control connection.

The electropneumatic valve arrangement preferably has a pressurization double check valve. A first pressurization double check valve inlet is preferably connected to the first electromagnetic switching valve, in particular to the first outlet of the first electromagnetic switching valve. A second pressurization double check valve inlet is preferably connected to the relay valve working connection. A pressurization double check valve outlet is preferably connected to the second control connection of the reversal relay valve. It should be understood that the pressurization double check valve is configured to always output the higher of the pressures prevailing at the two pressurization double check valve inlets via the pressurization double check valve outlet. The pressurization double check valve is preferably configured to connect that pressurization double check valve inlet at which the higher pressure prevails to the pressurization double check valve outlet. In particular, it is preferred that the first electromagnetic switching valve, preferably the second inlet of the first electromagnetic switching valve, is connected to a brake pressure connection of a front-axle brake pressure modulator. Thus, if the first service brake circuit or the service brake pressure modulator or the electronic service brake control unit fails or has a fault, the brake pressure from the front-axle brake pressure modulator can, via the first electromagnetic switching valve and the pressurization double check valve, be provided as second control pressure at the second control connection of the reversal relay valve, in order to thus additionally brake the vehicle by ventilating the spring brake cylinder.

The reversal relay valve preferably has at least one open position and one closed position. In the open position, the reversal relay valve is preferably configured to open up a pressurization path between the first reservoir connection and the working connection, in order to pressurize the spring brake cylinder. In the closed position, the reversal relay valve is preferably configured to open up a ventilation path between the working connection and the vent, in order to ventilate the spring brake cylinder. The reversal relay valve preferably has a reversal relay valve piston that is configured to be moved between the open position and the closed position. Here, depending on pressure equilibrium, intermediate positions are also provided.

The first reservoir connection of the reversal relay valve is preferably connected to the first compressed-air reservoir in order for compressed air to be supplied to the reversal relay valve. In an embodiment, the reversal relay valve has a second reservoir connection, which is connected to a second compressed-air reservoir. The provision of two reservoir connections on the reversal relay valve, which are fed from in each case one compressed-air reservoir, can further increase the fail-safety of the brake system, which can continue to be pressurized even in the event of a failure of one of the compressed-air reservoirs of the spring brake cylinders.

The electronically controllable pneumatic brake system preferably has a first voltage source and a second voltage source, wherein the first voltage source is provided for supplying electrical voltage to the electronic service brake control unit, and wherein the second voltage source is provided for supplying electrical voltage to the electronic control unit. Preferably, the first voltage source alternatively or additionally supplies electrical voltage to the parking brake module. The provision of mutually independent voltage sources can further increase the fail-safety of the brake system, because a failure of a single voltage source does not result in a total failure of the parking brake device.

The electronically controllable pneumatic brake system preferably has a redundancy brake pressure modulator and an electronic redundancy brake control unit. The redundancy brake pressure modulator is preferably connected to the electronic redundancy brake control unit, and preferably receives secondary switching signals from the electronic redundancy brake pressure control unit for the purposes of switching at least one electromagnetic valve of the redundancy brake pressure modulator. The electropneumatic valve arrangement is preferably actuated by the electronic redundancy brake control unit. The redundancy brake pressure modulator and the electronic redundancy service brake control unit are preferably units of a secondary system of the electronically controllable pneumatic brake system. The secondary system is preferably configured to modulate a service brake pressure for the at least one service brake actuator of the vehicle if a fault is identified in the primary system. The secondary system then preferably forms a redundancy level for the primary system, the redundancy level being provided in particular in vehicles with high levels of automation.

In a second aspect of the disclosure, the object mentioned in the introduction is achieved by a method for controlling a vehicle, in particular utility vehicle, having an electronically controllable pneumatic brake system, preferably according to any one of the above-described embodiments of an electronically controllable pneumatic brake system according to the first aspect of the disclosure. The method includes supplying compressed air to a first reservoir connection of a reversal relay valve of a parking brake device, wherein the reversal relay valve is configured for pressurizing and ventilating at least one first spring brake cylinder of the vehicle. The method includes pressurizing a first control connection of the reversal relay valve with a parking brake pressure from a parking brake module of the parking brake device, such that the spring brake cylinder is pressurized. It should thus be understood that the vehicle is in a traveling state and the parking brakes are released. In an operating situation, a service brake pressure for at least one first service brake actuator of the vehicle is preferably modulated by a first service brake pressure modulator in order to brake the vehicle. In a fault situation in which a fault which at least partially prevents the parking brake pressure from being modulated has been identified in the parking brake device and/or the parking brake module, the method provides for an electropneumatic valve arrangement to be actuated via an electronic control unit, which is independent of the parking brake module, in order to pressurize a second control connection of the reversal relay valve with a second control pressure, such that the spring brake cylinder is ventilated. Alternatively or additionally, in a fault situation in which a fault has been identified in the service brake pressure modulator and/or in an electronic service brake control unit which is connected to and provides primary switching signals to the service brake modulator for the purposes of switching at least one electromagnetic valve of the first service brake pressure modulator, wherein the fault is a fault which at least partially prevents braking in an operational level of the vehicle, the method preferably provides for the electropneumatic valve arrangement to be actuated via the electronic control unit, which is independent of the parking brake module, in order to pressurize the second control connection of the reversal relay valve with a or the second control pressure, such that the spring brake cylinder is ventilated. It should be understood that the vehicle can be braked and safely stopped by way of metered ventilation of the spring brake cylinder. If a parking brake module of the parking brake device is still functional, wherein the parking brake module is configured to provide a parking brake pressure at a parking brake pressure connection which is connected to the first control connection of the reversal relay valve, it is also possible for the spring brake cylinder to be ventilated, and the vehicle thus braked and safely stopped, by ventilating the first control connection of the reversal relay valve.

For an anti-compound function, the method preferably provides for compressed air to be supplied to the first reservoir connection of the reversal relay valve, for the electropneumatic valve arrangement to be actuated via the electronic control unit, which is independent of the parking brake module, in order to pressurize the second control connection of the reversal relay valve with a second control pressure, and for a third control connection of the reversal relay valve, which is connected to a first service brake pressure connection of the service brake pressure modulator, to be pressurized with a service brake pressure from the service brake pressure modulator, such that the spring brake cylinder is consequently pressurized. It should be understood that the anti-compound function is activated, for example, in a state in which the vehicle is stopped or parked and the parking brakes of the vehicle have been arrested. By pressurizing the spring brake cylinder, the associated parking brake can be released.

According to a third aspect of the disclosure, the object mentioned in the introduction is achieved by a vehicle, in particular utility vehicle, having a front axle, at least one first rear axle and an electronically controllable pneumatic brake system according to any one of the above-described embodiments of an electronically controllable pneumatic brake system according to the first aspect of the disclosure.

It should be understood that the electronically controllable pneumatic brake system according to the first aspect of the disclosure and the utility vehicle according to the third aspect of the disclosure have identical and similar sub-aspects. The first service brake circuit is preferably a rear-axle service brake circuit. The first service brake pressure modulator is preferably a rear-axle service brake pressure modulator, which has at least one first service brake pressure connection for modulating a service brake pressure for at least one first service brake actuator at a rear axle of the vehicle.

In a fourth aspect of the disclosure, the object mentioned in the introduction is achieved by the use of a reversal relay valve for pressurizing and ventilating at least one first spring brake cylinder of a vehicle. The reversal relay valve has a first control connection, a second control connection, a working connection, at least one first reservoir connection and a vent. The first control connection is connected to a parking brake pressure connection of a parking brake module in order to receive a parking brake pressure. The second control connection is connected to an electropneumatic valve arrangement in order to receive a second control pressure, wherein the electropneumatic valve arrangement is actuated by an electronic control unit which is independent of the parking brake module.

### BRIEF DESCRIPTION OF DRAWINGS

The invention will now be described with reference to the drawings wherein:

FIG. 1 is a schematic illustration of a first embodiment of the electronically controllable pneumatic brake system;

FIG. 2 is a schematic illustration of a second embodiment of the electronically controllable pneumatic brake system;

FIG. 3 is a schematic illustration of a third embodiment of the electronically controllable pneumatic brake system; and,

FIGS. 4A to 4E show switching positions of a reversal relay valve.

### DETAILED DESCRIPTION

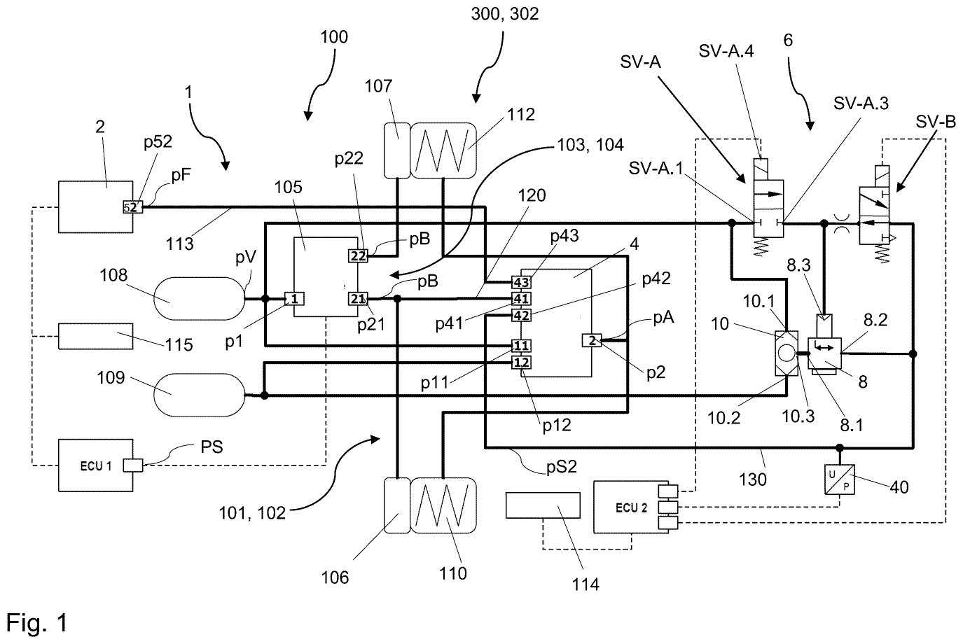

FIG. 1 shows an electronically controllable pneumatic brake system 100 having a parking brake device 1 according to the disclosure. The electronically controllable pneumatic brake system 100 is used in the present case in a vehicle 300 in the form of a utility vehicle 302, which is illustrated here in highly schematic form. In particular, a first axle 101 of the vehicle 300 is schematically illustrated. The first axle 101 is preferably a first rear axle 102 of the vehicle 300.

Here, the electronically controllable pneumatic brake system 100 has a first service brake actuator 106 and a second service brake actuator 107, for in each case one wheel of the vehicle 300. A first service brake circuit 103, in particular a first rear-axle service brake circuit 104, is provided for the purposes of providing a supply to the first and to the second service brake actuator 106, 107. The first and the second service brake actuator 106, 107 may also be referred to as first and second rear-axle service brake actuator 106, 107. Reservoir pressure pV is supplied to the first service brake circuit 103 from a first compressed-air reservoir 108.

Aside from the service brake actuators 106, 107, the brake system 100 has a first spring brake cylinder 110 and a second spring brake cylinder 112. In particular, the service brake actuators 106, 107 each have a spring brake cylinder 110, 112 and are configured as double-acting brake actuators, also referred to as Tristop cylinders. The spring brake cylinders 110, 112 are configured to apply the brakes of the vehicle 300 when unpressurized or ventilated. The spring brake cylinders 110, 112 can thus advantageously be utilized as parking brakes, to which no compressed air needs to be provided in order to brake the first axle 101. To release the wheels, the spring brake cylinders 110, 112 must be pressurized.

The first service brake circuit 103 has a first service brake pressure modulator 105. The service brake pressure modulator 105 has a first service brake pressure connection p21 for modulating a service brake pressure pB for the first service brake actuator 106 of the vehicle 300. The service brake pressure modulator 105 has a second service brake pressure connection p22 for modulating a service brake pressure pB for the second service brake actuator 107 of the vehicle 300. In other embodiments, the first service brake pressure connection p21 and the second service brake pressure connection p22 may however also be combined, and the first primary service brake pressure modulator 105 may thus be configured as a single-channel axle modulator. To receive a reservoir pressure pV, the service brake pressure modulator 105 has a compressed-air reservoir connection p1, via which the service brake pressure modulator 105 is connected to the first compressed-air reservoir 108.

The brake system 100 has an electronic service brake control unit ECU1, which is connected to the service brake pressure modulator 105. The electronic service brake control unit ECU1 is configured to provide primary switching signals PS to the service brake pressure modulator 105 for the purposes of switching at least one electromagnetic valve (not shown) of the first service brake pressure modulator 105. The electronic service brake control unit ECU1 preferably receives braking demand signals from a driver or from a virtual driver (not shown), on the basis of which the electronic service brake control unit ECU1 modulates the primary switching signals PS at the service brake pressure modulator 105. Preferably, the electronic service brake control unit ECU1 is connected via a vehicle bus to a unit for autonomous driving (virtual driver) and receives maneuver-related data (not shown) therefrom.

The parking brake device 1 has a parking brake module 2 and a reversal relay valve 4. The parking brake module 2 has a parking brake pressure connection p52 at which it can provide a parking brake pressure pF. The parking brake module 2 preferably reacts to a parking demand or a launch demand from a driver or from a virtual driver (not shown). In response to a launch demand, or during travel, the parking brake module 2 is preferably configured to provide the parking brake pressure pF. If the driver wishes to park, compressed air is no longer provided at the parking brake pressure connection p52, and as a result, the reversal relay valve 4 ventilates the spring brake cylinders 110, 112.

The reversal relay valve 4 has a first control connection p43 that is connected to the parking brake pressure connection p52. The parking brake pressure connection p52 is connected to the first control connection p43 via a parking brake compressed-air line 113. The first control connection p43 is configured to receive the parking brake pressure pF that is provided at the parking brake pressure connection p52. The reversal relay valve 4 furthermore has a second control connection p42. Via the second control connection p42, the reversal relay valve 4 is connected to an electropneumatic valve arrangement 6. Furthermore, in FIG. 1, the reversal relay valve 4 has a third control connection p41. The third control connection p41 is connected to the first service brake pressure connection p21, in particular via a first service brake compressed-air line 120. The third control connection p41 is configured to receive a service brake pressure pB from the service brake pressure modulator 105. It should be understood that the third control connection p41 may also be connected to the second service brake pressure connection p22 or, if the service brake pressure modulator 105 is configured as a single-channel axle modulator, to a combined service brake pressure connection.

The reversal relay valve 4 furthermore has a first reservoir connection p11, a second reservoir connection p12, a working connection p2 and a vent p3. The first reservoir connection p11 is connected to the first compressed-air reservoir 108. The second reservoir connection p12 is connected to a second compressed-air reservoir 109. The reversal relay valve 4 is thus supplied with compressed air both from the first compressed-air reservoir 108 and from the second compressed-air reservoir 109. Accordingly, the reversal relay valve 4 continues to be supplied with compressed air even if one of the compressed-air reservoirs 108, 109 fails.

The working connection p2 is connected to the first and to the second spring brake cylinder 110, 112. To pressurize the first and the second spring brake cylinder 110, 112, the reversal relay valve 4 provides a working pressure pA at the working connection p2. By providing the working pressure pA, the reversal relay valve 4 pressurizes the spring brake cylinders 110, 112 and thus releases the parking brake of the vehicle 300. To engage the parking brake of the vehicle 300, the reversal relay valve 4 can ventilate the spring brake cylinders 110, 112. For this purpose, the reversal relay valve 4 can fluidically connect the spring brake cylinders 110, 112 to the vent p3.

In FIG. 1, the electropneumatic valve arrangement 6 has a relay valve 8. The relay valve 8 has a relay valve reservoir connection 8.1, a relay valve working connection 8.2, a relay valve control connection 8.3 and a relay valve ventilation connection (not shown here). The relay valve reservoir connection 8.1 is connected via a reservoir double check valve 10 to the first compressed-air reservoir 108 and to the second compressed-air reservoir 109. It should be understood that the reservoir double check valve 10 is optional. The reservoir double check valve 10 has a first reservoir double check valve inlet 10.1, which is connected to the first compressed-air reservoir 108, a second reservoir double check valve inlet 10.2, which is connected to the second compressed-air reservoir 109, and a reservoir double check valve outlet 10.3, which is connected to the relay valve reservoir connection 8.1. The reservoir double check valve 10 is configured to always output the higher of the pressures prevailing at the two reservoir double check valve inlets 10.1, 10.2 via the reservoir double check valve outlet 10.3. That is, if a fault occurs in one of the two compressed-air reservoirs 108, 109, the relay valve 8 can continue to be supplied with compressed air. If no reservoir double check valve 10 is provided, the relay valve reservoir connection 8.1 is preferably connected to the first compressed-air reservoir 108. It should be understood that, if no reservoir double check valve 10 is provided, the relay valve reservoir connection 8.1 may also be connected to the second compressed-air reservoir 109. The relay valve working connection 8.2 of the relay valve 8 is connected to the second control connection p42, in particular via a control compressed-air line 130. Via the control compressed-air line 130, a second control pressure pS2 can be modulated at the second control connection p42 by the relay valve 8.

In FIG. 1, the electropneumatic valve arrangement 6 furthermore has a first electromagnetic switching valve SV-A. In FIG. 1, the first electromagnetic switching valve SV-A is configured as a 2/2 directional valve and has an open position and a closed position. The first electromagnetic switching valve SV-A is situated in the closed position when deenergized and in the open position when energized. In the open position, the electromagnetic switching valve SV-A connects the first compressed-air reservoir 108 to the relay valve control connection 8.3. The first electromagnetic switching valve SV-A is electronically actuated by an electronic control unit ECU2. The electronic control unit ECU2 is a control unit that is independent of the parking brake module 2. The electronic control unit ECU2 is a control unit that is independent of the electronic service brake control unit ECU1.

If a fault has been identified in the parking brake module 2, in particular if the parking brake module 2 modulates a parking brake pressure pF despite the fact that parking of the vehicle 300 is desired by the driver or virtual driver, the electronic control unit ECU2 modulates an electronic switching signal at the first electromagnetic switching valve SV-A such that the first electromagnetic switching valve SV-A switches from the closed position into the open position. When the first electromagnetic switching valve SV-A is in the open position, compressed air passes from the first compressed-air reservoir 108 to the relay valve control connection 8.3. If the relay valve 8 is actuated by the first electromagnetic switching valve SV-A, it switches into an open position and opens up a flow path between the relay valve reservoir connection 8.1 and the relay valve working connection 8.2. The compressed air then passes as second control pressure pS2 via the control compressed-air line 130 from the relay valve 8 to the second control connection p42. The reversal relay valve 4 is configured to ventilate the first and the second spring brake cylinder 110, 112 in a situation in which the first and the second control connection p43, p42 are pressurized, the third control connection p41 is ventilated and a reservoir pressure prevails at the first reservoir connection p11. Consequently, in this case, the parking brake of the vehicle 300 can be engaged, and the vehicle can be safely parked, even if there is a fault in the parking brake module 2.

Furthermore, in the event of a fault in the first service brake circuit 103, for example a fault of the first service brake pressure modulator 105 which has the effect that the vehicle 300 can no longer be braked by way of the first axle 101 and no service brake pressure pB prevails at the third control connection p41, the vehicle 300 can, in the alternative, be braked by virtue of the second control pressure pS2 being modulated at the second control connection p42 of the reversal relay valve 4.

The electropneumatic valve arrangement 6 furthermore has a second electromagnetic switching valve SV-B. The second electromagnetic switching valve SV-B is configured as a 3/2 directional valve. The second electromagnetic switching valve SV-B has a pass-through position and a ventilation position. The second electromagnetic switching valve SV-B is situated in the pass-through position when deenergized and in the ventilation position when energized. In the pass-through position, the second electromagnetic switching valve SV-B connects the relay valve working connection 8.2 to the relay valve control connection 8.3. The second electromagnetic switching valve SV-B thus allows compressed air to be recirculated from the relay valve working connection 8.2 to the relay valve control connection 8.3, such that the relay valve 8 remains actuated until such time as the second electromagnetic switching valve SV-B switches from the pass-through position into the closed position. The second electromagnetic switching valve SV-B is likewise actuated by the electronic control unit ECU2.

That is, if the second control connection p42 of the reversal relay valve 4 is to be pressurized, it suffices for the first electromagnetic switching valve SV-A to be briefly actuated in order that the relay valve 8 is actuated. The relay valve 8 thereafter remains actuated owing to the “loop” or the recirculation. If pressurization of the second control connection p42 is no longer desired, the second electromagnetic switching valve SV-B can be actuated by the electronic control unit ECU2 such that it switches into the ventilation position and the recirculation is interrupted.

To detect a pressure in the control compressed-air line 130, the brake system 100 has a first pressure sensor 40. The first pressure sensor 40 is connected to the electronic control unit ECU2 and provides signals, which correspond to the detected pressure, to the electronic control unit ECU2. The electronic control unit ECU2 is configured to use the signals from the first pressure sensor 40 to determine what pressure, or whether a pressure, is prevailing in the control compressed-air line 130. In the embodiment shown, the electronic control unit ECU2 can thus determine whether a second control pressure pS2 is prevailing at the second control connection p42 of the reversal relay valve 4. In this way, it can be checked whether the electropneumatic valve arrangement 6 is functional or has a fault.

The electronic service brake control unit ECU1 is supplied with electrical voltage from a first voltage source 115. The first voltage source 115 is furthermore also connected to the parking brake module 2 and is configured to supply electrical voltage to the parking brake module. By contrast, the electronic control unit ECU2 is supplied with electrical voltage from a second voltage source 114. The separate supply of voltage to the electronic service brake control unit ECU1 and to the electronic control unit ECU2 means that a failure of one of the voltage sources 114, 115 does not lead to a total failure of the parking brake device 1. The electronic control unit ECU2 is independent of the first voltage source 115. The electronic control unit ECU2 is independent of the electronic service brake control unit ECU1.

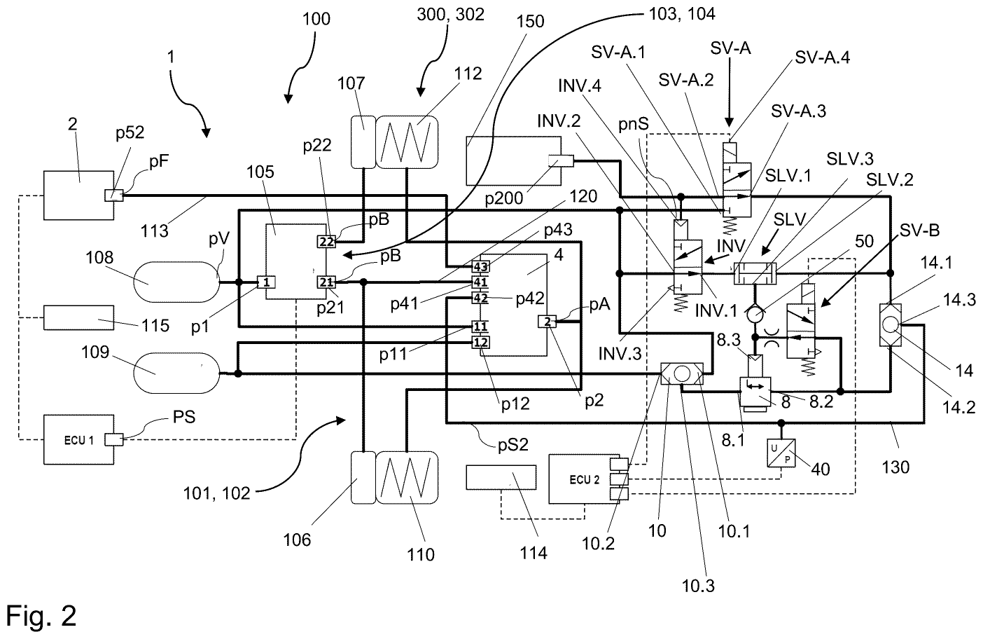

The embodiment in FIG. 2 differs from the embodiment in FIG. 1 in particular by the electropneumatic valve arrangement 6. Here, aside from the first electromagnetic switching valve SV-A, configured here as a 3/2 directional valve, and the second electromagnetic switching valve SV-B, the relay valve 8 and the reservoir double check valve 10, the electropneumatic valve arrangement 6 has a select-low valve SLV, a pneumatically switchable valve INV and a pressurization double check valve 14.

In FIG. 2, the pneumatically switchable valve INV is configured as a 3/2 directional valve and has a pass-through position and a ventilation position. The pneumatically switchable valve INV is situated in the pass-through position when unpressurized and in the ventilation position when pressurized. The pneumatically switchable valve INV has a first outlet INV.1, a first inlet INV.2, a ventilation outlet INV.3 and a pneumatic control connection INV.4. The select-low valve SLV has a first select inlet SLV.1, a second select inlet SLV.2 and a select outlet SLV.3. The first select inlet SLV.1 is connected to the pneumatically switchable valve INV, in particular to the first outlet INV.1 of the pneumatically switchable valve INV. The pneumatically switchable valve INV is configured to ventilate the first select inlet SLV.1 in response to a pneumatic control pressure pnS at the pneumatic control connection INV.4, that is, if the pneumatically switchable valve INV is pressurized. For this purpose, the pneumatically switchable valve INV switches into the ventilation position, that is, into a position in which the first outlet INV.1 is connected to the ventilation outlet INV.3.

The select-low valve SLV is configured to output the lower of the pressures prevailing at the two select inlets SLV.1, SLV.2 via the select outlet SLV.3. Thus, if the first select inlet SLV.1 is ventilated, it is also the case that no pressure is output via the select outlet SLV.3. The select outlet SLV.3 is connected, with the interposition of a check valve 50, to the relay valve control connection 8.3. That is, if no pressure is output via the select outlet SLV.3, the relay valve 8 cannot initially be actuated. Only if both the first select inlet SLV.1 and the second select inlet SLV.2 are pressurized can the relay valve 8 initially be actuated. The relay valve 8 thereafter remains actuated until such time as the second electromagnetic switching valve SV-B is actuated and the recirculation from the relay valve working connection 8.2 to the relay valve control connection 8.3 is thus interrupted. The check valve 50 is configured to confine the compressed air in the “loop”, such that the compressed air cannot escape via the select-low valve SLV and the ventilation outlet INV.3.

In FIG. 2, the pneumatic control connection INV.4 of the pneumatically switchable valve INV is connected to a brake pressure connection p200 of a front-axle brake pressure modulator 150. It should be understood that the pneumatic control connection INV.4 may also be connected to the first service brake pressure connection p21, to the second service brake pressure connection p22 or to a brake pressure connection of a redundancy brake pressure modulator. The pneumatic control connection INV.4 is configured to receive a brake pressure from the front-axle brake pressure modulator 150 as pneumatic control pressure pnS. That is, if the service brakes are operated, the pneumatically switchable valve INV is actuated with a brake pressure from the front-axle brake pressure modulator 150. In response to a brake pressure at the pneumatic control connection INV.4, the pneumatically switchable valve INV switches into the ventilation position and thus ventilates the first select inlet SLV.1. Since the pneumatic control connection INV.4 of the pneumatically switchable valve INV is connected to the brake pressure connection p200 of the front-axle brake pressure modulator 150, the pneumatically switchable valve INV can be actuated even if the first service brake pressure modulator 105 has a fault.

As already described in the introduction, the first electromagnetic switching valve SV-A is configured, in FIG. 2, as a 3/2 directional valve. The electromagnetic switching valve SV-A has a first inlet SV-A.1, a second inlet SV-A.2, a first outlet SV-A.3 and an electronic control connection SV-A.4. The first inlet SV-A.1 of the first electromagnetic switching valve SV-A is connected to the first compressed-air reservoir 108. The second inlet SV-A.2 of the first electromagnetic switching valve SV-A is connected to the brake pressure connection p200 of the front-axle brake pressure modulator 150. It should be understood that the second inlet SV-A.2 of the first electromagnetic switching valve SV-A may also be connected to the first service brake pressure connection p21, to the second service brake pressure connection p22 or to a brake pressure connection of a redundancy brake pressure modulator. The first outlet SV-A.3 of the first electromagnetic switching valve SV-A is connected to the second select inlet SLV.2. The electronic control connection SV-A.4 of the first electromagnetic switching valve SV-A is connected to the electronic control unit ECU2. When deenergized, the first electromagnetic switching valve SV-A is situated in a position in which the second inlet SV-A.2 is connected to the first outlet SV-A.3. When energized, the first electromagnetic switching valve SV-A is situated in a position in which the first inlet SV-A.1 is connected to the first outlet SV-A.3.

That is, if the service brakes are operated, the pneumatically switchable valve INV is actuated with a brake pressure from the front-axle brake pressure modulator. The pneumatically switchable valve INV switches into the ventilation position and ventilates the first select inlet SLV.1. Furthermore, the brake pressure that is modulated by the front-axle brake pressure modulator 150 is passed through from the second inlet SV-A.2 of the first electromagnetic switching valve SV-A to the first outlet SV-A.3 of the first electromagnetic switching valve SV-A and passes to the second select inlet SLV.2. Consequently, the first select inlet SLV.1 is ventilated and the second select inlet SLV.2 is pressurized, whereby the first select outlet SLV.3 is ventilated. As a result, the relay valve 8 cannot initially be actuated, and no pressure is output from the relay valve 8 via the relay valve working connection 8.2.

In order that a second control pressure pS2 can nevertheless be provided at the second control connection p42 of the reversal relay valve 4, the electropneumatic valve arrangement 6 has the pressurization double check valve 14. A first pressurization double check valve inlet 14.1 of the pressurization double check valve 14 is connected to the first electromagnetic switching valve SV-A, in particular to the first outlet SV-A.3 of the first electromagnetic switching valve SV-A. A second pressurization double check valve inlet 14.2 of the pressurization double check valve 14 is connected to the relay valve working connection 8.2. A pressurization double check valve outlet 14.3 of the pressurization double check valve 14 is connected to the second control connection p42 of the reversal relay valve 4. The pressurization double check valve 14 is configured to output the higher of the pressures prevailing at the two pressurization double check valve inlets 14.1, 14.2 via the pressurization double check valve outlet 14.3.

If the service brakes are operated, the brake pressure that is modulated by the front-axle brake pressure modulator 150 is passed through from the second inlet SV-A.2 of the first electromagnetic switching valve SV-A to the first outlet SV-A.3 of the first electromagnetic switching valve SV-A and provided not only to the second select inlet SLV.2 but also at the first pressurization double check valve inlet 14.1. Since a higher pressure then prevails at the first pressurization double check valve inlet 14.1 than at the second pressurization double check valve inlet 14.2 (in this case, owing to the pneumatically switchable valve INV, no pressure prevails if the service brakes are operated), the pressurization double check valve 14 connects the first pressurization double check valve inlet 14.1 to the pressurization double check valve outlet 14.2. Consequently, a second control pressure pS2 is provided at the second control connection p42 of the reversal relay valve 4.

It is expedient for a second control pressure pS2 to prevail at the second control connection p42 of the reversal relay valve 4 in particular in order that, in the event of a fault in which the first service brake circuit 103 or the first service brake pressure modulator 105 or the electronic service brake control unit ECU1 fails or has a fault, the front-axle brake pressure modulator 150 nevertheless remains functional and can actuate at least one first front-axle service brake actuator (not shown) in order to additionally brake the vehicle 300 by ventilating the first and the second spring brake cylinder.

In the event of a fault in which both the first service brake pressure modulator 105 and/or the electronic service brake control unit ECU1 fails or has a fault and the front-axle brake pressure modulator 150 fails or has a fault, it is possible, by electronic actuation of the first electromagnetic switching valve SV-A by the electronic control unit ECU2, for the first electromagnetic switching valve SV-A to be switched into the position in which the first inlet SV-A.1 of the first electromagnetic switching valve SV-A is connected to the first outlet SV-A.3 of the first electromagnetic switching valve SV-A. Compressed air is consequently passed through from the first compressed-air reservoir 108 to the second select inlet SLV.2 and the first pressurization double check valve inlet 14.1. In this case, compressed air is also present at the second pressurization double check valve inlet 14.2. Since the pneumatically switchable valve INV remains unpressurized if the front-axle brake pressure modulator 150 fails or has a fault, the pneumatically switchable valve passes compressed air from the first compressed-air reservoir 108 through to the first select inlet SLV.1. At the select-low valve SLV, compressed air is then present both at the first select inlet SLV.1 and at the second select inlet SLV.2, whereby the first select outlet SLV.3 is also pressurized. The relay valve 8 is actuated and switches into an open position and opens up a flow path between the relay valve reservoir connection 8.1 and the relay valve working connection 8.2. The compressed air then passes from the relay valve working connection 8.2 to the second pressurization double check valve inlet 14.2. From the pressurization double check valve outlet 14.3, the compressed air then passes as second control pressure pS2 to the second control connection p42 of the reversal relay valve 4, whereby the vehicle 300 can be braked by virtue of the first and the second spring brake cylinders 110, 112 being ventilated.

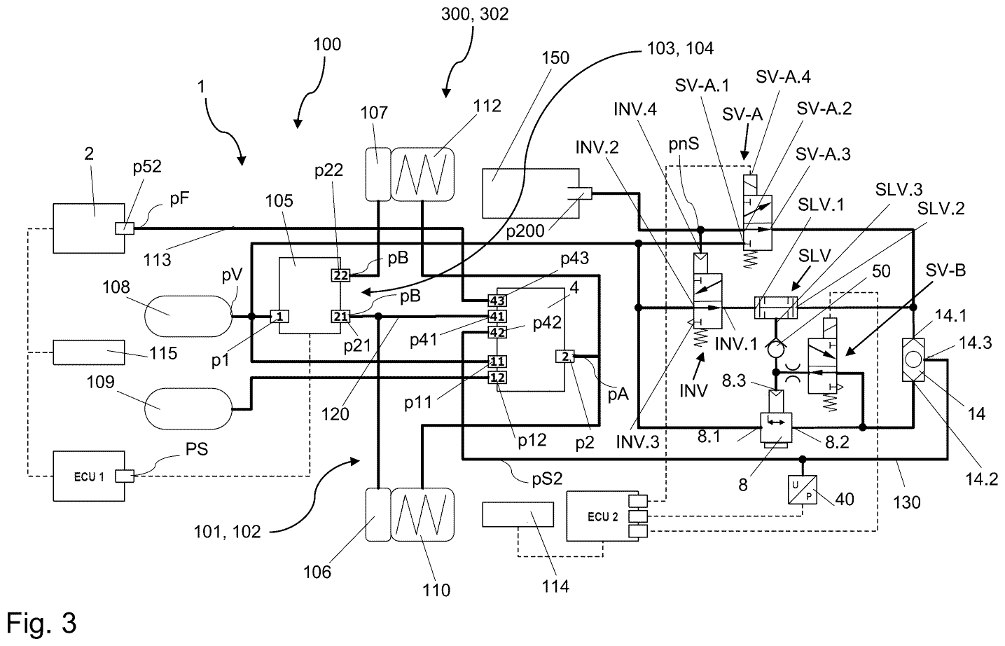

The embodiment in FIG. 3 differs from the embodiment in FIG. 2 in that the electropneumatic valve arrangement 6 does not have a reservoir double check valve 10. It should be understood that the embodiment in FIG. 1 may also be implemented without a reservoir double check valve 10. Owing to the omission of the reservoir double check valve 10, space can be saved, and the circuit complexity can be reduced.

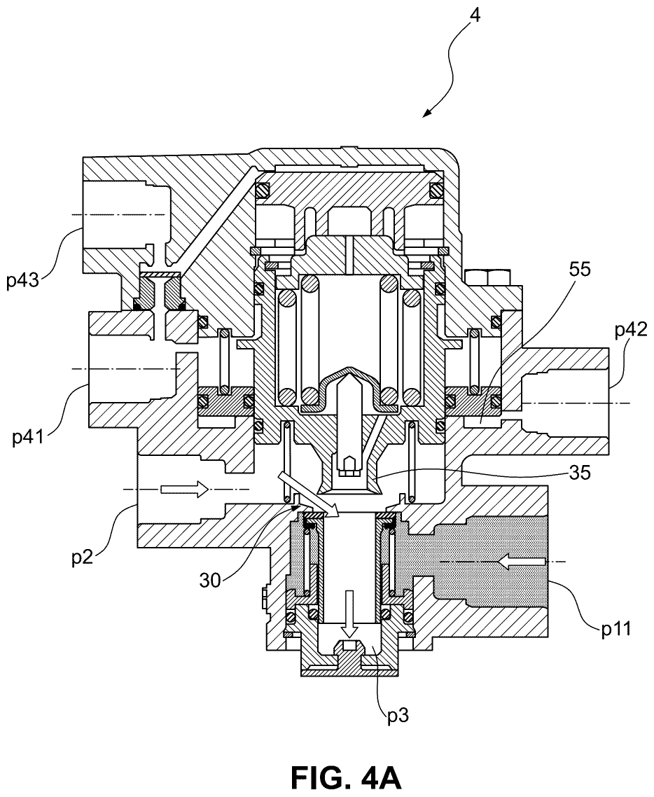

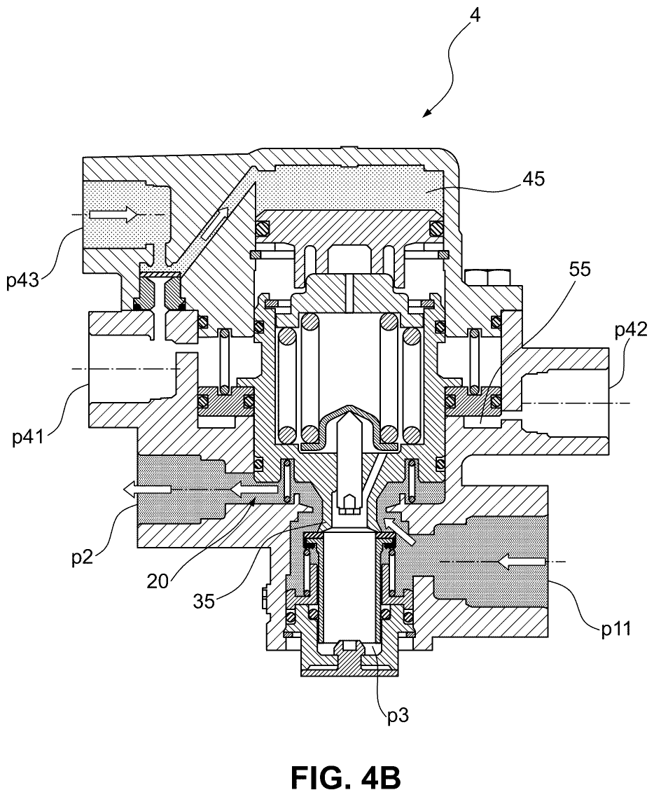

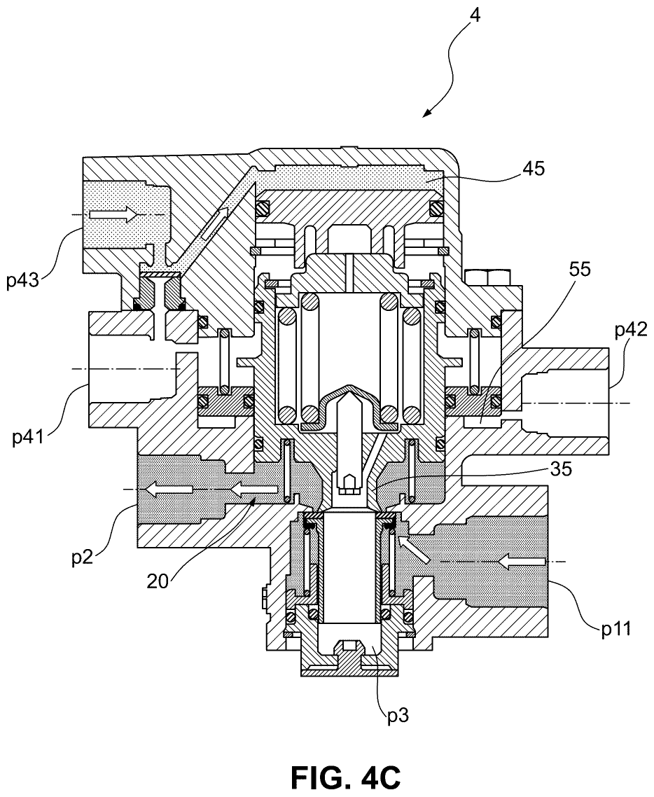

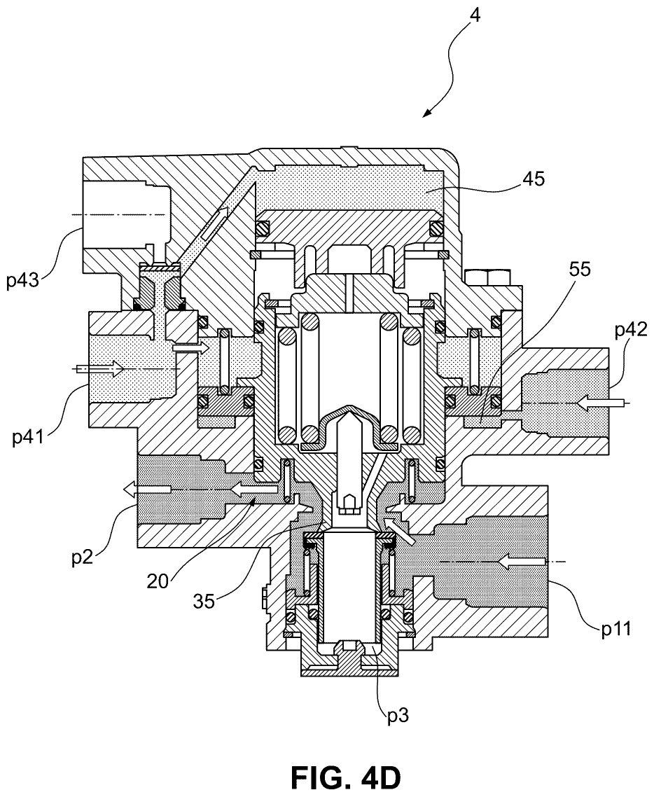

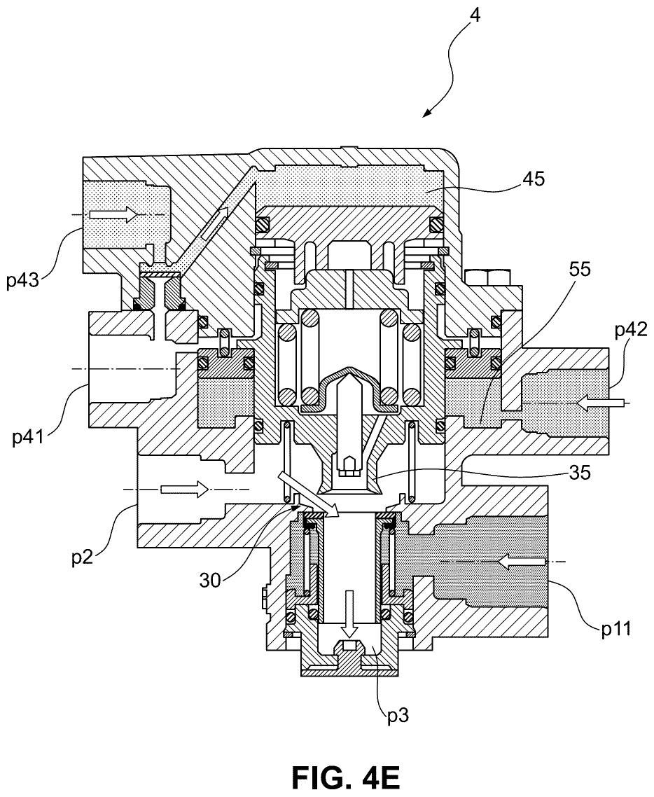

FIG. 4A shows a first switching state of the reversal relay valve 4 in an operating situation in which the parking brakes of the vehicle are arrested, that is, the first and the second spring brake cylinder 110, 112 are ventilated. It should be understood that the construction of such reversal relay valves 4 is known from the prior art. The following statements regarding the switching states of the reversal relay valve 4 are intended in particular to impart better understanding of the disclosure. The reversal relay valve 4 has the first control connection p43, the second control connection p42, the third control connection p41, the working connection p2, the first reservoir connection p11 and the vent p3. It should be understood that the illustrated reversal relay valve 4 may also have the second reservoir connection p12. With regard to the manner in which the connections are interconnected, reference is made to the description of the figures given above.

The reversal relay valve 4 has an open position and a closed position. In the open position, the reversal relay valve 4 is configured to open up a pressurization path 20 between the first reservoir connection p11 and the working connection p2, in order to pressurize the first and the second spring brake cylinder 110, 112. In the closed position, the reversal relay valve 4 is preferably configured to open up a ventilation path 30 between the working connection p2 and the vent p3, in order to ventilate the first and the second spring brake cylinder 110, 112. The reversal relay valve 4 has a reversal relay valve piston 35 that is configured to be moved between the open position and the closed position.

In FIG. 4A, the reversal relay valve 4 is situated in the closed position; the ventilation path 30 between the working connection p2 and the vent p3 is thus opened up, and the first and the second spring brake cylinder 110, 112 are ventilated. In the operating situation illustrated, neither the first, the second nor the third control connection p43, p42, p41 is pressurized. The vehicle 300 is thus in a parked state, and the service brakes are not operated.

FIG. 4B shows a second switching state of the reversal relay valve 4 in an operating situation when the parking brakes of the vehicle 300 are released. For this purpose, the parking brake module 2 provides a parking brake pressure pF at the first control connection p43. The first control connection p43 of the reversal relay valve 4 is thus pressurized. The parking brake pressure pF passes from the first control connection p43 into a first compressed-air chamber 45 of the reversal relay valve 4. The pressure in the first compressed-air chamber 45 has the effect that the reversal relay valve piston 35 is moved from the closed position into the open position, with FIG. 4B showing the open position. For the movement of the reversal relay valve piston 35 from the closed position into the open position, the reversal relay valve piston 35 is pushed in a downward vertical direction by the pressure in the first compressed-air chamber 45. In this switching state, the second control connection p42 and the third control connection p43 are ventilated.

In the open position, the reversal relay valve 4 opens up a pressurization path 20 between the first reservoir connection p11 and the working connection p2, and the first and the second spring brake cylinder 110, 112 are pressurized. It should be understood that FIG. 4B shows a switching state in which the reversal relay valve 4 is not yet in a balanced position, and the parking brakes have not yet been fully released.

FIG. 4C then shows a third switching state of the reversal relay valve 4 in an operating situation in which the reversal relay valve 4 is in a balanced position. The reversal relay valve 4 is situated in the open position and opens up the pressurization path 20 between the first reservoir connection p11 and the working connection p2, such that the first and the second spring brake cylinder 110, 112 remain pressurized. The parking brakes are fully released, and the vehicle 300 is in a traveling state.

FIG. 4D shows a fourth switching state of the reversal relay valve 4 in an operating situation for an anti-compound function. The anti-compound function serves for the avoidance of mechanical overloading of the brake pistons as a result of summation of braking forces from the service brakes and the spring brakes. It should be understood that the anti-compound function is utilized if the service brakes are operated while the parking brakes are active. The first reservoir connection p11 is supplied with compressed air. The first control connection p43 is ventilated. The second and the third control connection p42, p41 are pressurized. The pressurization of the second and of the third control connection p42, p41 results from the operation of the service brakes (in this regard, see the statements made in relation to FIG. 2) or from actuation of the electropneumatic valve arrangement 6, in particular from actuation of the first electromagnetic switching valve SV-A (in this regard, see the statements made in relation to FIG. 1). The service brake pressure pB, which prevails at the third control connection p41, passes from the third control connection p41 into the first compressed-air chamber 45 of the reversal relay valve 4. The pressure in the first compressed-air chamber 45 has the effect that the reversal relay valve piston 35 is moved from the closed position into the open position, with FIG. 4D showing the open position. For the movement of the reversal relay valve piston 35 from the closed position into the open position, the reversal relay valve piston 35 is pushed in a downward vertical direction by the pressure in the first compressed-air chamber 45. In the open position, the first reservoir connection p11 and the working connection p2 are now connected to one another, such that the first and the second spring brake cylinder 110, 112 are pressurized while the service brakes are operated. It should be understood that, if a second control pressure pS2 prevails at the second control connection p42, this does not have any effect on the anti-compound function of the reversal relay valve 4. It should furthermore be understood that the anti-compound function does not require a second control pressure pS2 to prevail at the second control connection p42. For the anti-compound function, it suffices for the third control connection p41 to be pressurized, as would be the case, for example, in the embodiment of FIG. 1 if the service brakes are operated while the parking brakes are arrested.

FIG. 4E shows a fifth switching state of the reversal relay valve 4 in a first fault situation. The fault situation includes a fault in the parking brake module 2 and/or in the first service brake circuit 103, in particular in the first service brake pressure modulator 105, and/or in the electronic service brake control unit ECU1. In the event of a fault in the parking brake module 2, the parking brake module 2 modulates a parking brake pressure pF at the first control connection p43 despite the fact that it is intended for the vehicle 300 to be parked. In this case, in order that the vehicle 300 can nevertheless be safely parked, the second control connection p42 is pressurized. If the reversal relay valve 4 is used in an electronically controllable pneumatic brake system 100 as illustrated in FIG. 1, the electropneumatic valve arrangement 6, in particular the first electromagnetic switching valve SV-A, is actuated by the electronic control unit ECU2 in order to pressurize the second control connection p42. When energized, first electromagnetic switching valve SV-A switches into the open position, such that compressed air passes from the first compressed-air reservoir 108 to the relay valve control connection 8.3. The relay valve 8 is thus actuated and consequently modulates the second control pressure pS2 at the second control connection p42 of the reversal relay valve 4. If the reversal relay valve 4 is used in an electronically controllable pneumatic brake system 100 as illustrated in FIG. 2 or FIG. 3, it is likewise possible, by electronic actuation of the first electromagnetic switching valve SV-A by the electronic control unit ECU2, for the first electromagnetic switching valve SV-A to be switched into the position in which the first inlet SV-A.1 of the first electromagnetic switching valve SV-A is connected to the first outlet SV-A.3 of the first electromagnetic switching valve SV-A. Compressed air is consequently passed through from the first compressed-air reservoir 108 to the second select inlet SLV.2 and the first pressurization double check valve inlet 14.1. In this case, compressed air is also present at the second pressurization double check valve inlet 14.2. Specifically, the pneumatically switchable valve INV passes compressed air originating from the first compressed-air reservoir 108 through to the first select inlet SLV.1. Pressure thus prevails both at the first select inlet SLV.1 and at the second select inlet SLV.2, such that pressure also prevails at the select outlet SLV.3 and at the relay valve control connection 8.3. The relay valve 8 switches into the open position and, via the relay valve working connection 8.2, modulates pressure at the second pressurization double check valve inlet 14.2. From the pressurization double check valve outlet 14.3, the compressed air then passes as second control pressure pS2 to the second control connection p42 of the reversal relay valve 4.

The second control pressure ps2, which prevails at the second control connection p42, passes from the second control connection p42 into a second compressed-air chamber 55 of the reversal relay valve. The pressure in the second compressed-air chamber 55 has the effect that the reversal relay valve piston 35 is moved from the open position into the closed position, with FIG. 4E showing the closed position. For the movement of the reversal relay valve piston 35 from the open position into the closed position, the reversal relay valve piston 35 is pushed in an upward vertical direction by the pressure in the second compressed-air chamber 55. In the closed position, the ventilation path 30 between the working connection p2 and the vent p3 is opened up, such that the first and the second spring brake cylinder 110, 112 can be ventilated in metered fashion, and the vehicle 300 can be safely braked and parked. At least one specification heading is required.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 Parking brake device
2 Parking brake module
4 Reversal relay valve
6 Electropneumatic valve arrangement
8 Relay valve
8.1 Relay valve reservoir connection
8.2 Relay valve working connection
8.3 Relay valve control connection
10 Reservoir double check valve
10.1 First reservoir double check valve inlet
10.2 Second reservoir double check valve inlet
10.3 Reservoir double check valve outlet
14 Pressurization double check valve
14.1 First pressurization double check valve inlet
14.2 Second pressurization double check valve inlet
14.3 Pressurization double check valve outlet
20 Pressurization path
30 Ventilation path
35 Reversal relay valve piston
40 Pressure sensor
45 First compressed-air chamber
50 Check valve
55 Second compressed-air chamber
100 Electronically controllable pneumatic brake system
101 First axle
102 First rear axle
103 First service brake circuit
104 First rear-axle service brake circuit
105 First service brake pressure modulator
106 First service brake pressure actuator
107 Second service brake pressure actuator
108 First compressed-air reservoir
109 Second compressed-air reservoir
110 First spring brake cylinder
112 Second spring brake cylinder
113 Parking brake compressed-air line
114 Second voltage source
115 First voltage source
120 Service brake compressed-air line
130 Control compressed-air line
150 Front-axle brake pressure modulator
300 Vehicle
302 Utility vehicle
ECU1 Electronic service brake control unit
ECU2 Electronic control unit
INV Pneumatically switchable valve
INV.1 First outlet of the pneumatically switchable valve
INV.2 First inlet of the pneumatically switchable valve
INV.3 Ventilation outlet of the pneumatically switchable valve
INV.4 Pneumatic control connection
SLV Select-low valve
SLV.1 First select inlet
SLV.2 Second select inlet
SLV.3 Select outlet
SV-A First electromagnetic switching valve
SV-A.1 First inlet of the first electromagnetic switching valve
SV-A.2 Second inlet of the first electromagnetic switching valve
SV-A.3 First outlet of the first electromagnetic switching valve
SV-A.4 Electronic control connection of the first electromagnetic switching valve
SV-B Second electromagnetic switching valve
pA Working pressure
pB Service brake pressure
pF Parking brake pressure
pnS Pneumatic control pressure
PS Primary switching signals
pS2 Second control pressure
PV Reservoir pressure
p1 Compressed-air reservoir connection
p2 Working connection
p3 Vent
p11 First reservoir connection
p12 Second reservoir connection
p21 First service brake pressure connection
p22 Second service brake pressure connection
p41 Third control connection
p42 Second control connection
p43 First control connection
p52 Parking brake pressure connection
p200 Brake pressure connection of the front-axle brake pressure modulator

1. An electronically controllable pneumatic brake system for a vehicle, the electronically controllable pneumatic brake system comprising:
at least one first service brake circuit having a first service brake pressure modulator;
said first service brake pressure modulator having at least one first service brake pressure connection for modulating a service brake pressure for at least one first service brake actuator of the vehicle;
said first service brake pressure modulator being connected to a first compressed-air reservoir in order to receive reservoir pressure;
an electronic service brake control unit connected to said first service brake pressure modulator and configured to provide primary switching signals to said first service brake pressure modulator for the purposes of switching at least one electromagnetic valve of said first service brake pressure modulator;
a parking brake device having a parking brake module and a reversal relay valve;
said parking brake module having a parking brake pressure connection;
said parking brake module being configured to provide a parking brake pressure at said parking brake pressure connection;
said reversal relay valve being for pressurizing and ventilating at least one first spring brake cylinder of the vehicle;
said reversal relay valve having a first control connection, a second control connection, a working connection, at least one first reservoir connection, and a vent;
said first control connection being connected to said parking brake pressure connection in order to receive the parking brake pressure;
said working connection being connected to said at least one spring brake cylinder;
said second control connection being connected to an electropneumatic valve arrangement in order to receive a second control pressure which differs from the service brake pressure;
said electropneumatic valve arrangement being configured to be actuated by an electronic control unit which is independent of the parking brake module; and, said reversal relay valve being configured to pressurize the at least one spring brake cylinder in a situation in which said first control connection is pressurized, said second control connection is ventilated and the reservoir pressure prevails at said at least one first reservoir connection, and to ventilate the spring brake cylinder in a situation in which said first control connection and said second control connection are pressurized and the reservoir pressure prevails at said at least one first reservoir connection.

2. The electronically controllable pneumatic brake system of claim 1, wherein:
said reversal relay valve has a third control connection which is connected to said first service brake pressure connection in order to receive the service brake pressure;
said reversal relay valve is configured to pressurize the at least one spring brake cylinder in a situation in which said first control connection and said third control connection are pressurized, said second control connection is pressurized or ventilated, and the reservoir pressure prevails at said at least one first reservoir connection;
said reversal relay valve is configured to ventilate the spring brake cylinder in a situation in which said first control connection and said second control connection are pressurized, the third control connection is ventilated and the reservoir pressure prevails at said at least one first reservoir connection; and,
said reversal relay valve is configured to pressurize the at least one spring brake cylinder in a situation in which said second control connection and said third control connection are pressurized, said first control connection is ventilated and the reservoir pressure prevails at said at least one first reservoir connection.

3. The electronically controllable pneumatic brake system of claim 1, wherein said first service brake pressure modulator and said electronic service brake control unit are integrated in one module and are implemented as a structural unit.

4. The electronically controllable pneumatic brake system of claim 1, wherein said electropneumatic valve arrangement is independent of a service brake function of the electronically controllable pneumatic brake system.

5. The electronically controllable pneumatic brake system of claim 1, wherein said electropneumatic valve arrangement is bistable.

6. The electronically controllable pneumatic brake system of claim 5, wherein said electropneumatic valve arrangement is configured to maintain an assumed switching position if energization is withdrawn.

7. The electronically controllable pneumatic brake system of claim 1, wherein said electropneumatic valve arrangement has a relay valve; said relay valve has a relay valve reservoir connection, a relay valve working connection, and a relay valve control connection; said relay valve working connection is connected to said second control connection of said reversal relay valve; and, said electropneumatic valve arrangement has a first electromagnetic switching valve which is configured such that, when energized, it allows compressed air to pass through from the first compressed-air reservoir to said relay valve control connection.

8. The electronically controllable pneumatic brake system of claim 7, wherein said electropneumatic valve arrangement has a second electromagnetic switching valve; said second electromagnetic switching valve has a pass-through position and a ventilation position; and, said second electromagnetic switching valve, when deenergized, is situated in said pass-through position and connects said relay valve working connection to said relay valve control connection.

9. The electronically controllable pneumatic brake system of claim 7 further comprising:
a reservoir double check valve arranged upstream of said relay valve reservoir connection; and,
said reservoir double check valve having a first reservoir double check valve inlet connected to the first compressed-air reservoir and a second reservoir double check valve inlet connected to a second compressed-air reservoir.

10. The electronically controllable pneumatic brake system of claim 7, wherein said electropneumatic valve arrangement has a select-low valve and a pneumatically switchable valve having a pneumatic control connection; said pneumatically switchable valve has a pass-through position and a ventilation position; said select-low valve has a first select inlet, a second select inlet and a select outlet; said first select inlet is connected to said pneumatically switchable valve; said second select inlet is connected to said first electromagnetic switching valve; said select outlet is connected to said relay valve control connection; and, said pneumatically switchable valve is configured to ventilate said first select inlet in response to a pneumatic control pressure at said pneumatic control connection.

11. The electronically controllable pneumatic brake system of claim 10, wherein said pneumatic control connection of said pneumatically switchable valve is connected to said first service brake pressure connection or to a brake pressure connection of a front-axle brake pressure modulator or to a brake pressure connection of a redundancy brake pressure modulator in order to receive the pneumatic control pressure.

12. The electronically controllable pneumatic brake system of claim 7, wherein said first electromagnetic switching valve is connected to said first service brake pressure connection or to a brake pressure connection of a front-axle brake pressure modulator or to a brake pressure connection of a redundancy brake pressure modulator; and, said first electromagnetic switching valve is configured such that, when deenergized, it allows a brake pressure to pass through to said relay valve control connection.

13. The electronically controllable pneumatic brake system of claim 12, wherein said electropneumatic valve arrangement has a pressurization double check valve having a first pressurization double check valve inlet connected to the first electromagnetic switching valve;
said pressurization double check valve has a second pressurization double check valve inlet connected to said relay valve working connection; and, said pressurization double check valve has a pressurization double check valve outlet connected to said second control connection of said reversal relay valve.

14. The electronically controllable pneumatic brake system of claim 1, wherein said reversal relay valve has an open position and a closed position; said reversal relay valve is configured such that, in the open position, said reversal relay valve opens up a pressurization path between said first reservoir connection and said working connection in order to pressurize the at least one spring brake cylinder; and, said reversal relay valve is configured such that, in the closed position, said reversal relay valve opens up a ventilation path between said working connection and said vent in order to ventilate the at least one spring brake cylinder.

15. The electronically controllable pneumatic brake system of claim 1, wherein said first reservoir connection of said reversal relay valve is connected to said first compressed-air reservoir in order to supply compressed air to said reversal relay valve.

16. The electronically controllable pneumatic brake system of claim 1, wherein said reversal relay valve has a second reservoir connection that is connected to a second compressed-air reservoir.

17. The electronically controllable pneumatic brake system of claim 1 further comprising:
a first voltage source for supplying electrical power to said electronic service brake control unit; and,
a second voltage source for supplying electrical power to said electronic control unit.

18. The electronically controllable pneumatic brake system of claim 1 further comprising:
a redundancy brake pressure modulator;
an electronic redundancy brake control unit;
said redundancy brake pressure modulator being connected to said electronic redundancy brake control unit and configured to receive secondary switching signals from said electronic redundancy brake control unit for switching at least one electromagnetic valve of said redundancy brake pressure modulator; and,
said electropneumatic valve arrangement being configured to be actuated by said electronic redundancy brake control unit.

19. The electronically controllable pneumatic brake system of claim 1, wherein the vehicle is a utility vehicle.

20. A method for controlling a vehicle having an electronically controllable pneumatic brake system, the method comprising:
supplying compressed air to a first reservoir connection of a reversal relay valve of a parking brake device, wherein the reversal relay valve is configured for pressurizing and ventilating at least one first spring brake cylinder of the vehicle;
pressurizing a first control connection of the reversal relay valve with a parking brake pressure from a parking brake module of the parking brake device, such that the at least one spring brake cylinder is pressurized;
in an operating situation, modulating a service brake pressure for at least one first service brake actuator of the vehicle via a first service brake pressure modulator in order to brake the vehicle; and,
in a fault situation in which a fault which at least partially prevents the parking brake pressure from being modulated has been identified in the parking brake device, actuating an electropneumatic valve arrangement via an electronic control unit, which is independent of the parking brake module, in order to pressurize a second control connection of the reversal relay valve with a second control pressure, such that the at least one spring brake cylinder is ventilated.

21. The method of claim 20, wherein, for an anti-compound function:
compressed air is supplied to the first reservoir connection of the reversal relay valve;
the electropneumatic valve arrangement is actuated via the electronic control unit, which is independent of the parking brake module, in order to pressurize the second control connection of the reversal relay valve with a second control pressure; and,
a third control connection of the reversal relay valve, which is connected to a first service brake pressure connection of the first service brake pressure modulator, is pressurized with the service brake pressure from the first service brake pressure modulator such that the at least one spring brake cylinder is pressurized.

22. The method of claim 20, wherein the vehicle is a utility vehicle.

23. The method of claim 20, wherein the electronically controllable pneumatic brake system includes:
at least one first service brake circuit having the first service brake pressure modulator;
the first service brake pressure modulator having the at least one first service brake pressure connection for modulating the service brake pressure for the at least one first service brake actuator of the vehicle;
the first service brake pressure modulator being connected to a first compressed-air reservoir in order to receive reservoir pressure;
an electronic service brake control unit connected to the first service brake pressure modulator and configured to provide primary switching signals to the first service brake pressure modulator for the purposes of switching at least one electromagnetic valve of the first service brake pressure modulator;
the parking brake device having the parking brake module and the reversal relay valve;
the parking brake module having a parking brake pressure connection;
the parking brake module being configured to provide the parking brake pressure at the parking brake pressure connection;
the reversal relay valve having the first control connection, a second control connection, a working connection, at least one first reservoir connection, and a vent;
the first control connection being connected to the parking brake pressure connection in order to receive the parking brake pressure;
the working connection being connected to the at least one spring brake cylinder;
the second control connection being connected to the electropneumatic valve arrangement in order to receive the second control pressure which differs from the service brake pressure; and,
the reversal relay valve being configured to pressurize the at least one spring brake cylinder in a situation in which the first control connection is pressurized, the second control connection is ventilated and a reservoir pressure prevails at the first reservoir connection, and to ventilate the at least one spring brake cylinder in a situation in which the first control connection and the second control connection are pressurized and the reservoir pressure prevails at the first reservoir connection.

24. A vehicle comprising a front axle, a rear axle and the electronically controllable pneumatic brake system of claim 1.

25. A method of operating a reversal relay valve, the method comprising:
pressurizing at least one first spring brake cylinder of a vehicle via the reversal relay valve;
ventilating the at least one first brake cylinder of the vehicle via the reversal relay valve;
wherein the reversal relay valve has a first control connection, a second control connection, a working connection, at least one first reservoir connection and a vent;
wherein the first control connection is connected to a parking brake pressure connection of a parking brake module in order to receive a parking brake pressure;
wherein the second control connection is connected to an electropneumatic valve arrangement in order to receive a second control pressure which differs from a service brake pressure; and,
wherein the electropneumatic valve arrangement is configured to be actuated by an electronic control unit which is independent of the parking brake module.
